(19) United States
(12) Patent Application Publication
(10) Pub. No.: US 2006/0262655 A1
(43) Pub. Date: Nov. 23, 2006

(54) Device for storing and protecting a data carrier

(76) Inventor: Claes Persson, Oslo (NO)

Correspondence Address: YOUNG & THOMPSON, 745 SOUTH 23RD STREET, 2ND FLOOR, ARLINGTON, VA, 22202, US

(21) Appl. No.: 10/529,584

(22) PCT Filed: Sep. 11, 2003
(86) PCT No.: PCT/NO03/00315

§ 371 Date: Mar. 29, 2005

(30) Foreign Application Priority Data
Sep. 30, 2002 (NO) 20024671

(51) Int. Cl. H04B 1/20

(52) U.S. Cl. 369/1

(57) ABSTRACT

A device is described for storing and protecting a data carrier from inadvertent erasure of data, in the form of a holder (1) comprising shielding metal sheets (2, 3) so arranged as to envelop the data carrier, wherein the holder (1) is made of a sheet material that is bent or folded or assembled in some other manner so that the holder (1) has the form of a first (2) and a second (3,4,5) parallel planar portion connected via the fold, wherein the first portion (2) is dimensioned so as to essentially completely overlap a data carrier, and the second portion is dimensioned so as to completely overlap a datacarrying element such as a magnetic strip and/or a chip or integrated circuit or the like arranged on or in the data carrier when the data carrier has been fully inserted in the holder (1).

The invention relates to storage and protection of data carriers, and more specifically the invention relates to a device for storing and protecting a card comprising a data-carrying element from inadvertent erasure of data and/or other damage, in the form of a holder comprising shielding metal sheets so arranged that they envelop the data-carrying element, as disclosed in the preamble of independent patent claim 1.

There has been an explosive development in the use of data carriers in the form of different types of cards equipped with a magnetic strip and/or a microchip, as for instance bank cards, various payment cards, keycards, membership cards etc. However, a growing problem is that the information stored in the magnetic strip or the microchip can be erased or damaged by magnetism or electromagnetic and/or radio radiation. For instance, the use of magnetic fasteners on handbags and the like represents a major source of demagnetisation. Other erase sources may be mobile telephones, loudspeakers, transformers, high-voltage conductors and similar electromagnetic interference sources. Indeed, even radiation from computer screens and television sets and static electricity from textiles or the like can in unfavourable situations probably erase data from such cards. As their number increases, breakage and physical wear of cards of this type is also a growing problem.

In what follows, there is specific mention of or reference to credit cards, but this is intended to comprise all cards of a similar or related type.

As is well known, credit cards are read by means of data stored on a magnetic strip. This strip consists of ferromagnetic particles in the micrometer size range. These magnetic particles have a north-south axis that is parallel to the strip. Data is stored by shifting to the opposite polarity locally in the strip. The magnetic field strength capable of shifting the polarity is called the coercivity of the card. Credit cards or bank cards used in Norway are of so-called LoCo (low coercivity) quality which have a coercivity of Hc=300 Oersted (Oe). Alternatively, the magnetic strip may be of so-called HiCo (high coercivity) quality of up to Hc=4000 Oe, which also has more mechanical wear resistance. The reason LoCo cards are used in Norway is that automatic cash dispensers are to be able to record information on the card. Abroad, and especially in the USA, the use of HiCo for credit cards is more widespread. However, HiCo strips are more typically used for access or keycards that are read several times a day and which are not updated as frequently as a credit card.

Credit cards have three tracks containing data in the magnetic strip. It is standard to have letters and numbers in track 1, which typically contains name, account number, expiry date, PIN code etc. Track 2 contains account number, expiry date etc. Track 3 contains numbers from a national standard. In Norway, information is stored in track 3, whilst this is not as common abroad. It is envisaged that future credit cards will be equipped with a chip in addition to the magnetic strip. However, such chips are already used in telephone cards and similar cash cards, so-called smart cards.

As mentioned above, the problem of inadvertent erasure of data is a growing one, and in Norway the banks have statistics which show that a large number of the cases of accidental demagnetisation occur because of the magnetic fastener on ladies' handbags.

The problem of magnetic shielding of data carriers is nothing new and, e.g., special boxes made of magnetic shielding materials are known to have been proposed for the storage and protection of computer disks and the like.

Also when it comes to devices for storing bank and credit cards, cases and covers have been proposed for shielding against inadvertent erasure of data. For example, publicly available NO Patent Application 19974021 describes a device of the type in question where the card is placed between two thin sheets of metal that are connected by a flexible intermediate member so that a case is formed. In this document reference is made to a number of US patents which concern related devices.

As further examples of relevant art in the field, reference may be made to U.S. Pat. Nos. 4,593,736, 4,647,714 and 5,941,375, of which the first-named document relates to a case or bag for protecting and housing cards containing magnetically stored information. The case has a portion made of a magnetic shielding plate or mesh that is to act to prevent magnetic forces or fields from penetrating into the box and affecting the stored information. The case is clearly intended for the storage of several cards, and in the illustrated or described physical embodiment it may act as a “special wallet” designed for several cards, and not as single card protection for an individual card.

The second document relates to a composite sheet material for magnetic and electronic shielding. This material may well be quite interesting per se, but the document neither illustrates nor describes anything that appears to anticipate the novelty of the invention as defined in the present patent claims.

U.S. Pat. No. 5,941,375 is believed to represent the art that is closest to the invention, as it describes a protective card holder of the type in question designed for a single card. The card holder is made of plastic panels that are assembled in such manner that the card to be protected can be placed between two panels on which magnetic shielding metal is provided in the areas where the magnetic strip of the card is located when the card is placed in the holder. The illustrated protective device seems relatively difficult or complicated and time-consuming to produce, and it is also clear that it will not be able to protect a chip which is normally positioned in the middle of the card.

The known devices will probably function as intended. However, it is clear that there has been no proposal of a solution which in a simple, inexpensive and elegant manner ensures the desired protection of data carriers such as credit cards and related cards. For example, known credit card holders have in use shown an inadequate ability to protect against the magnetic field from a magnetic fastener on a lady's handbag. Sometimes the selection of material has also meant that over time the magnetic strip is demagnetised without the influence of any external factor. Therefore, it is clear that the known devices have deficiencies and drawbacks which do not make them optimally suitable for the object which forms the basis of the invention.

Accordingly, the object of the invention is to provide a device for storing and protecting a data carrier, which does not suffer from the deficiencies or drawbacks of the known devices or means of this type. This is achieved by a device of the type mentioned in the above which is characterised by the features disclosed in the characterising clause of independent claim 1.

Advantageous embodiments of the invention are disclosed in the dependent patent claims.

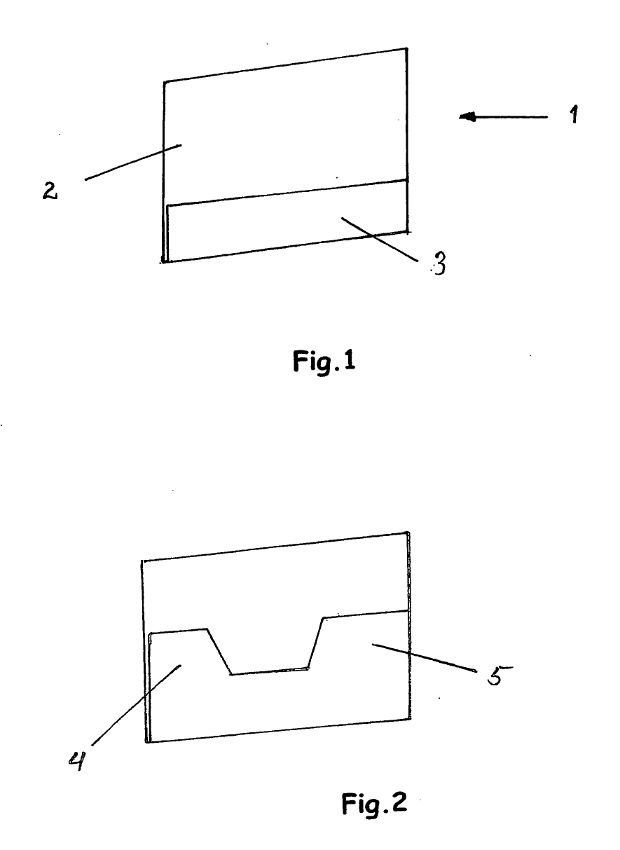

The invention will now be described with reference to the drawing, wherein FIGS. 1 and 2 are schematic illustrations of respectively a first and a second embodiment of the device according to the invention.

Reference numeral 1 in the drawing indicates a holder for a data carrier, for example, a credit card, not shown. The holder is made of a sheet material that is bent or folded so as to be shaped in the form of two connected, parallel planar portions, 2 and 3 respectively. In use, the card to be protected is placed in the holder 1 between the two planar portions, oriented so that the magnetic strip is located between the two portions. One of the portions 2 is given a size or extent which essentially corresponds to the size or extent of the card, whilst the other portion 3 only extends some distance from the bend or fold area so that it overlaps the extent or size of the magnetic strip when the card is fully inserted between the two portions.

FIG. 2 shows a variant wherein the second portion is made of two portions 4 and 5 which extend a greater distance from the bend area than the portion 3 in FIG. 1, and is specifically designed for the protection of cards equipped with a microchip.

The choice of sheet material is very important. It must have high magnetic permeability in order to protect the card and a high saturation level so as not to lose it protective ability against powerful magnetic fields. It must also be a so-called soft ferromagnetic material so that it does not become a permanent magnet. After extensive tests during is which many types of steel were tested, the applicant found that the material class Electrical Steel has magnetic properties that meet the requirements for the protection of credit cards of LoCo quality. In particular, transformer sheet metal has been found to be suitable for use as holder material. The inventor believes that a material of this kind may also be suitable for being placed directly on mobile telephones to shield against undesirable radiation. It is then envisaged that the material can be made in the form of a fine mesh that is fitted on the earpiece of mobile telephones, or optionally also/or that the whole of or parts of the cover can be made of such a material.

A prototype of holder 1 has been made, consisting of 0.27 mm thick 27ZDKH95 transformer sheet from Nippon Steel. This has been found to give satisfactory protection during tests with a typical magnet in women's handbags with a field of a maximum of 70 mT. When a credit card or bank card was placed in a holder of transformer sheet, the information on the card was not erased by the effect of such a field.

The holder 1 may also have an outer layer of a wear-resistant material applied thereto, for example, an elastomer or a suitable plastic material. This will ensure further protection as the distance to the magnet, on direct contact with the holder, will be increased. The layer may be provided with distinctive marks in the form of a logo, advertising or other decoration or the like.

In addition, the holder 1 may be equipped with a suitable cleaning layer on the inside of one of the sides 2, 3 facing the magnetic strip. The layer may be made of a suitable, relatively soft rubber material, felt material or the like, optionally a plastic or elastomeric material which, apart from cleaning the strip when the card is inserted into or withdrawn from the holder 1, also helps to keep the card in place without the planar portions 2, 3 needing to exert very much pressure on the card in order to hold it in place. The cleaning effect may advantageously also be used on contact points on smart cards.

The holder according to the invention provides adequate protection of the data carrier against inadvertent erasure of data as a result of external impact, it ensures good physical protection of the whole carrier or card material and it provides adequate cleaning of the magnetic strip and possible contact points on smart cards or the like. If desirable, several holders can be arranged as a composite unit or case thereby providing simple and secure storage of several cards together.

1. A device for storing and protecting a card comprising a data-carrying element from inadvertent erasure of data and/or other damage, in the form of a holder (1) comprising shielding metal sheets (2, 3) so arranged that they envelop the data-carrying element, characterised in that the metal sheets of the holder (1) are produced from one uniform piece of sheet material that is bent or folded so that the holder (1) has the form of a first sheet portion (2), and a second, parallel sheet portion (3, 4, 5) connected to the first sheet portion (2) via the fold and at a distance from the first sheet portion (2) that corresponds approximately to the thickness of the card to be protected, and wherein the first sheet portion (2) in terms of area is dimensioned so that it essentially completely overlaps the whole surface area of the card, and the second sheet portion (3, 4, 5) in terms of area is dimensioned so that it completely overlaps the data-carrying element in the form of a magnetic strip and/or a chip, integrated circuit or the like, arranged on or in the card, when the card has been fully inserted into the holder (1).

2. A device according to claim 1, characterised in that the holder (1) on its external plane sides has applied thereto a layer or coating.

3. A device according to claim 2, characterised in that the layer is provided with distinctive marks in the form of a logo, advertising or other decoration or the like.

4. A device according to claim 1, characterised in that the holder (1) is equipped with a suitable cleaning layer on the inside of the sides (2, 3) facing the magnetic strip, optionally also the chip.

5. A device according to claim 4, characterised in that the cleaning layer is made of a suitable relatively soft rubber material, felt material or the like.

6. A device according to claim 1, characterised in that the shielding metal is selected from the material class “Electrical Steel”.

7. A device according to claim 6, characterised in that the shielding metal is transformer sheet.

8. A device according to claim 1, characterised in that the shielding metal has a thickness in the range of 0.25-1.0 mm.

9. A device according to claim 1, characterised in that the shielding metal has a thickness of 0.29 mm.

10. A device according to claim 1, characterised in that the card containing the data carrier is one of a credit card, bank card, cash card, membership card, and keycard.

11. The device of claim 8, wherein the shielding metal has a thickness of about 0.27 mm.

12. The device of claim 2, wherein the coating is a wear-resistant material.

13. The device of claim 12, wherein the coating is one of an elastomer and a suitable plastic material.

14. A device according to claim 2, characterised in that the holder (1) is equipped with a suitable cleaning layer on the inside of the sides (2, 3) facing the magnetic strip, optionally also the chip.

15. A device according to claim 3, characterised in that the holder (1) is equipped with a suitable cleaning layer on the inside of the sides (2, 3) facing the magnetic strip, optionally also the chip.

16. A device according to claim 2, characterised in that the shielding metal is selected from the material class “Electrical Steel”.

17. A device according to claim 3, characterised in that the shielding metal is selected from the material class “Electrical Steel”.

18. A device according to claim 4, characterised in that the shielding metal is selected from the material class “Electrical Steel”.

19. A device according to claim 5, characterised in that the shielding metal is selected from the material class “Electrical Steel”.

20. A device according to claim 2 characterised in that the shielding metal has a thickness in the range of 0.25-1.0 mm.
